(19) United States
(12) Patent Application Publication
(10) Pub. No.: US 2004/0263940 A1
(43) Pub. Date: Dec. 30, 2004

(54) System and method for adjusting an illumination modulator in an imaging system

(76) Inventors: Bryan Comeau, Atkinson, MH (US); Philip Rombult, Boxford, MA (US); Jeffrey Knox, Lynnfield, MA (US)

Correspondence Address: Agfa Corporation, Law & Patent Department, 200 Ballardvale Street, Wilmington, MA, 01887-1069, US

(21) Appl. No.: 10/609,306

(22) Filed: Jun. 27, 2003

(51) Int. Cl. G02F 1/01; G02B 26/00

(52) U.S. Cl. 359/239

(57) ABSTRACT

An illumination modulator correction system is disclosed for adjusting the operational parameters of an illumination modulator in an imaging system. The correction system includes a modulator pattern unit for providing a test pattern on the illumination modulator, a modulator adjustment unit for permitting an actuation voltage on the illumination modulator to be changed through a range of actuation voltage values, a detector for receiving a modulated illumination field from the illumination modulator, a sampling unit for determining at least one sample value for at least one area of the modulated illumination field, and an evaluation unit for determining a minimum sample value within the range of actuation voltage values of the illumination modulator.

### BACKGROUND

The invention generally relates to imaging systems, and relates in particular to imaging systems that employ an illumination modulator.

Imaging system such as those disclosed in U.S. Pat. No. 6,433,934, may include an illumination source, a field lens system, an illumination modulator, imaging optics and an imaging surface. During imaging, the field lens system directs the illumination field onto the light modulator and the light modulator reflects the illumination field toward the imaging surface in one mode and reflects the illumination field away from the imaging surface in another mode. For example, the modulator may include a Grating Light Valve (GLV) as sold by Silicon Light Machines of Sunneyvale, Calif., and the system may direct via the imaging optics either the zero order reflection or the first order reflection toward the imaging surface in various embodiments.

Many imaging systems employ an illumination field that is generally in the shape of a line of illumination, permitting a line of picture elements (or pixels) to be imaged simultaneously. It has been discovered, however, that certain modulators (e.g., those that employ electric potentials to actuate selected ribbons in a GLV) may develop an unwanted charge on one or more of the ribbons or may simply operate optimally at different voltages for a variety of reasons, detracting from the performance of the system and quality of the recorded images. Such variations in actuation potentials may occur, for example, due to variations in the wavelength of the illumination field, due to the alignment of the illumination field on the GLV, due to variations in the available supply voltages, due to variations within the manufacturing tolerances of the GLV, and/or due to variations in the operating temperature of the GLV.

There is a need, therefore, for a system and method for efficiently and economically adjusting the performance of a GLV during operation.

### SUMMARY

The invention provides an illumination modulator correction system for adjusting the operational parameters of an illumination modulator in an imaging system. The correction system includes a modulator pattern unit for providing a test pattern on the illumination modulator, a modulator adjustment unit for permitting an actuation voltage on the illumination modulator to be changed through a range of actuation voltage values, a detector for receiving a modulated illumination field from the illumination modulator, a sampling unit for determining at least one sample value for at least one area of the modulated illumination field, and an evaluation unit for determining a minimum sample value within the range of actuation voltage values of the illumination modulator.

### BRIEF DESCRIPTION OF THE ILLUSTRATED EMBODIMENTS

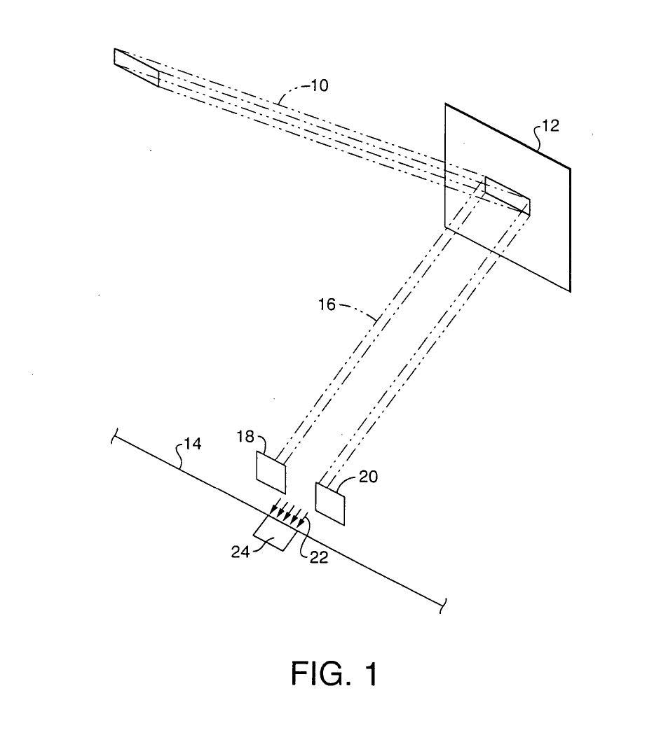

FIG. 1 shows an illustrative diagrammatic view of an imaging system employing a GLV correction system in accordance with an embodiment of the invention;

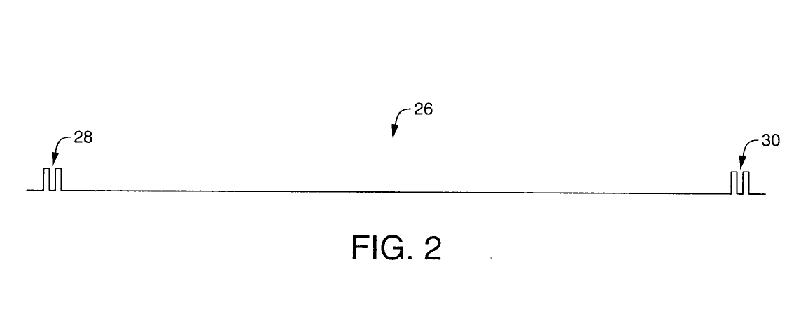

FIG. 2 shows an illustrative diagrammatic view of a modulator test pattern in accordance with an embodiment of the invention;

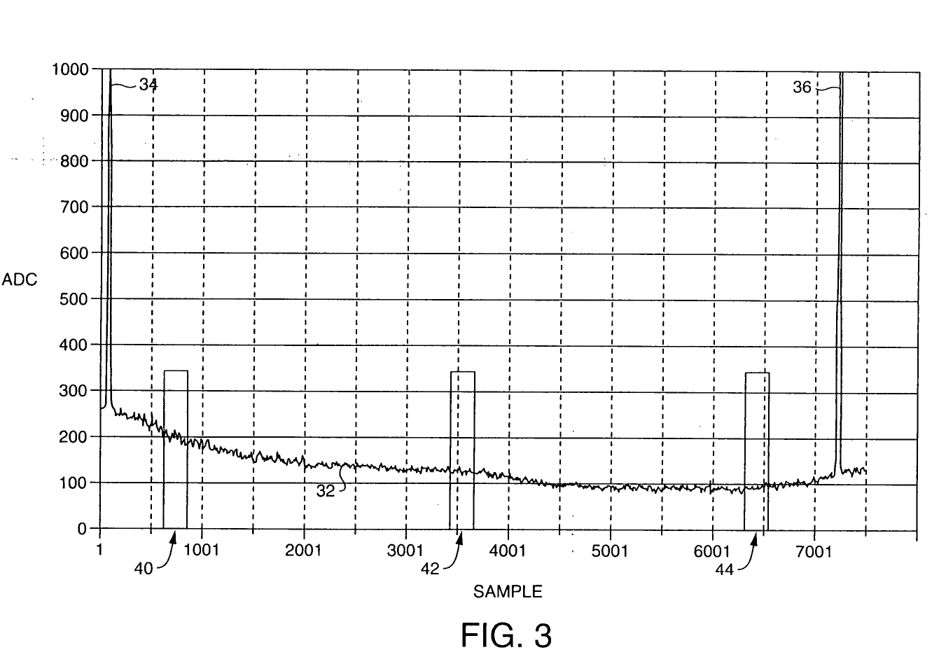

FIG. 3 shows an illustrative graphical representation of a scan image with three sample regions using the modulator test pattern of FIG. 2;

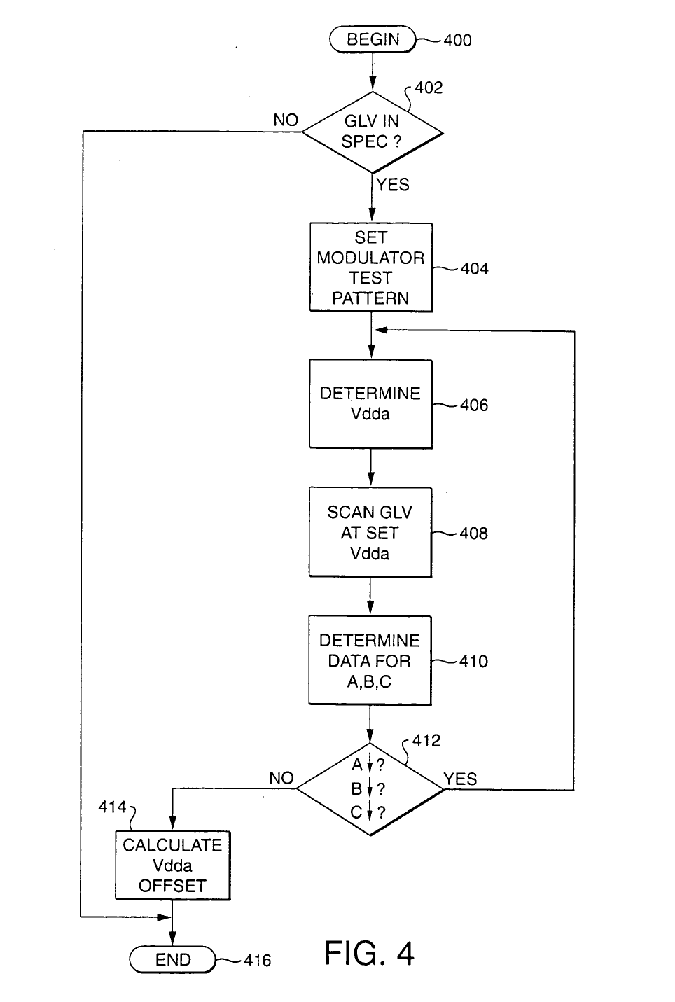

FIG. 4 shows an illustrative diagrammatic flow diagram of a process for measuring rollover values for different portions of a scan;

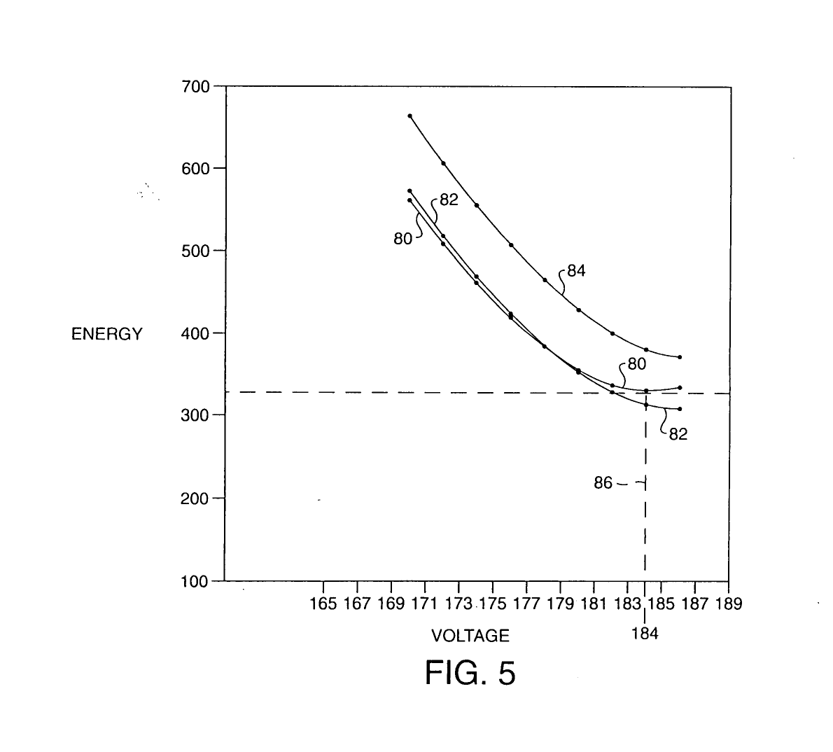

FIG. 5 shows an illustrative diagrammatic graphical view of a method for determining an optimal offset voltage;

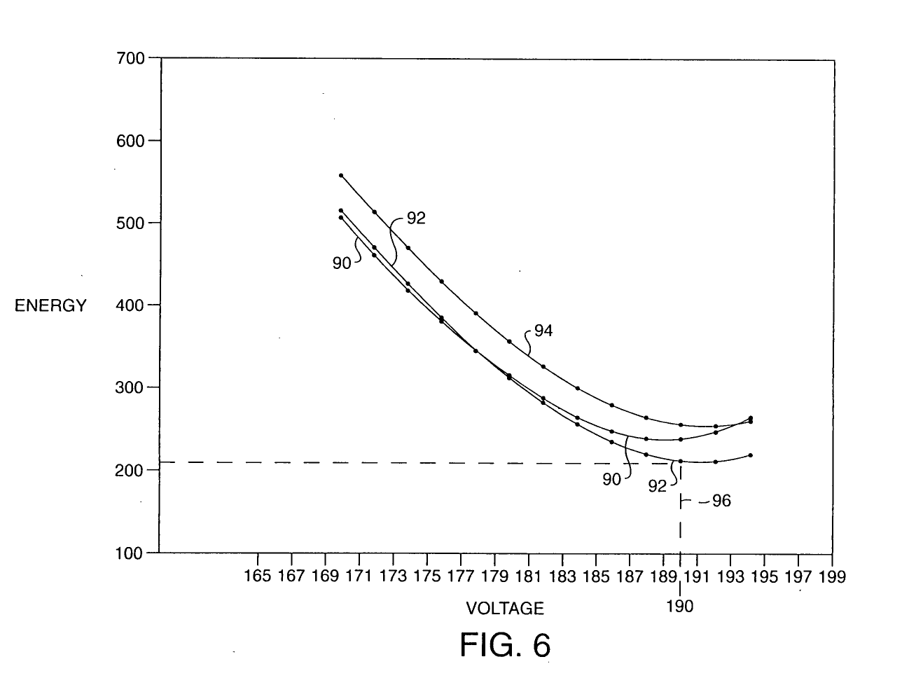

FIG. 6 shows an illustrative diagrammatic graphical view of another method for determining an optimal offset voltage;

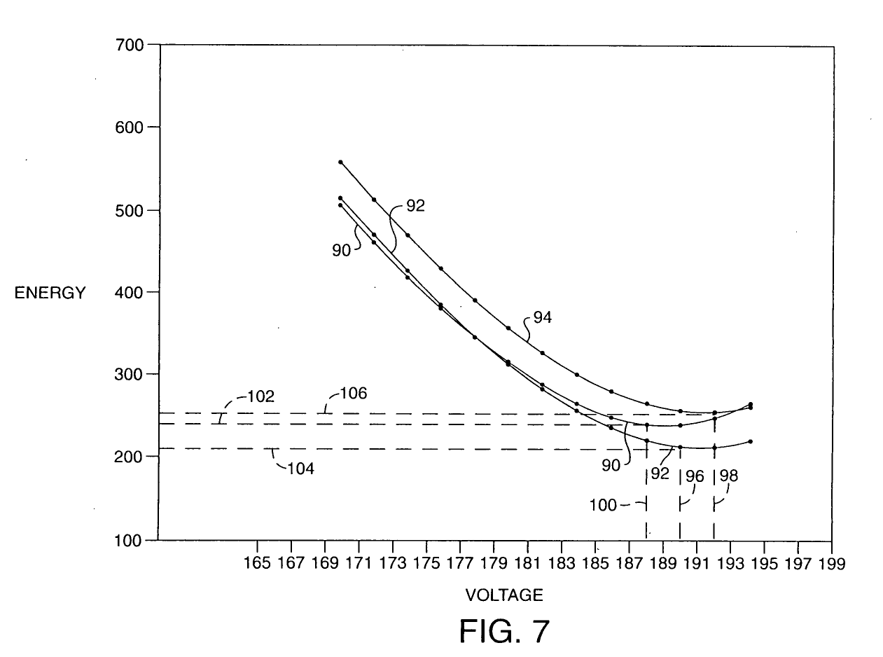

FIG. 7 shows an illustrative diagrammatic graphical view of further methods for determining an optimal offset voltage.

The drawings are shown for illustrative purposes only.

### DETAILED DESCRIPTION OF THE ILLUSTRATED EMBODIMENTS

As shown in FIG. 1, an imaging system (e.g., a thermal imaging system) in accordance with an embodiment of the invention may include a illumination field 10, an illumination modulator 12 and an imaging surface 14 (e.g., an external imaging drum). The modulator receives the illumination field 10 via a field lens system (not shown) and directs a modulated illumination field 16 toward the imaging surface via imaging optics (not shown). The illumination source, field lens system, modulator, imaging optics and imaging surface may be as disclosed in U.S. Pat. No. 6,433,934, the disclosure of which is hereby incorporated by reference. The modulator may include a Grating Light Valve (GLV) as sold by Silicon Light Machines of Sunneyvale, Calif.

The system also includes a pair of block plates 18 and 20 that prevent the end-most portions of the illumination field from reaching the imaging surface during normal scanning while permitting the central portion 22 of the modulated illumination field 16 to reach the imaging surface. A detector 24 is also placed at the image plane of the imaging surface adjacent imagable media. As shown at 26 in FIG. 2, a modulator test pattern may be employed having two pairs of adjacent ribbons on at each end (as shown at 28 and 30) with the remaining ribbons off between the ends.

During a single GLV evaluation scan in a slow scan direction (e.g., along the longitudinal length of imaging surface), the detector (e.g., having a slit opening of about 10 microns), may receive an illumination field as shown at 32 in FIG. 3. The illumination field includes two high intensity spikes 32 and 34 that correspond to the ends 28 and 30 of FIG. 2. The detector 24 is moved across the entire field 16 during charge build-up detection.

The pull down voltage for the GLV (e.g., about +15 volts) is optimized when a maximum of the applied illumination is diffracted into the +/−first order directions in an embodiment of the invention. As shown in FIG. 3, therefore, samples may be taken at three defined periods as shown at 40, 42 and 44 for a scan using a predetermined value for the actuation voltage for the GLV (e.g., the last know optimal value minus a fixed amount). During each of these sample periods, 100 samples are taken and analyzed (about 10 samples per GLV shutter), and the average sample value for each period is then determined. For example, let the average value for the sample period 40 be designated as average sample A, and the average value for the sample period 42 be designated as average sample B, and the average value for the sample period 44 be designated as average sample C. The system may then adjust the value of the voltage used to actuate the GLV and then record a subsequent set of values A, B, C for a subsequent scan. This process may then be repeated until one of the values A, B, C reaches a minimum value and begins to rise.

In particular, a process in accordance with an embodiment of the invention may begin (step 400) by determining whether the GLV is within specification (step 402). For example, the process may determine whether the GLV is properly aligned and whether the GLV has any charge build-up. If the GLV is determined to be within specification then the process ends (step 416). Otherwise, the process proceeds to setting a modulation test pattern (step 404), of for example 2 shutters on, 720 off, and 2 on as discussed above. The process then determines the appropriate voltage V_{dda} for the GLV (step 406). This voltage is initially set to a starting voltage (e.g., the last known optimal V_{dda} minus some fixed range value). The process then sets the V_{dda} to the external drum interface module and scans the modulated illumination field from the GLV across the detector 24 (step 408). The process then determines the values A, B and C from the samples in the sample periods 40, 42 and 44 (step 410).

In accordance with an embodiment, the process then determines whether the current values for A, B and C are less than the prior values for A, B and C from the prior scan (step 412). The prior values for A, B and C should be initially set to a relatively high number when the procedure begins. As long as the present values are is less than the prior respective values, the process continues to loop through steps 406, 408, 410 and 412 as shown, each time increasing the value of V_{dda} by a small increment at step 406. Once the current value of one of the values (A, B and C) is no longer negative, (e.g., B as shown), the process determines the new V_{dda} offset to optimize the system (step 414) and the process ends (step 416).

FIG. 5 shows an illustrative graphical representation of the above process in which the value of V_{dda} is slowly increased until the first of the value (e.g., B as shown at 80) reaches a minimum. The values of A and C are shown at 84 and 82 respectively. The value of V_{dda}, is then set to the voltage level at the value of B at rollover as shown at 86. For example, a digital-to-analog converter may be used to drive voltage increments (of for example, 1 to 100 mv). The values shown on the horizontal axis are digital values for driving such a voltage adjustor. In further embodiments, the system may simply monitor the changes in values for B only and wait until the values for B cease to decrease irrespective of the values of A and C. This may be desired, for example, if it is known that the values for section B will be lower than the values for sections A and C and/or may be subject to less distortion than the values for sections A and C in the full scan as shown in FIG. 3.

As shown in FIG. 7, in accordance with a further embodiment of the invention, the value of V_{dda} may be set to the voltage level (e.g., 190 units) as shown at 96 responsive to the second section to hitting rollover B as shown at 94. The values of C are shown at 92. In accordance with this procedure, the voltage level is set when the second section to hit rollover occurs. As shown in FIG. 6, the first section to hit rollover was section A as shown at 90.

In further embodiments, the system may wait until the last section hits rollover (as shown at 98), or may use the voltage associated with the lowest energy value at rollover. For example, if section A hits rollover at voltage level 100 and energy level 102, section B hits rollover at voltage level 96 and energy level 104, and section C hits rollover at voltage level 98 and energy level 104, then the system may choose the voltage level (96) that is associated with the lowest energy level. In further embodiments, systems may determine average value and/or employ interpolation from any of the recorded sections to determine an optical voltage offset value for a particular system.

Those skilled in the art will appreciate that numerous modifications and variations may be made to the above disclosed embodiments without departing from the spirit and scope of the invention.

What is claimed is:

1. An illumination modulator correction system for adjusting the operational parameters of an illumination modulator in an imaging system, said correction system comprising:
modulator pattern generation unit for providing a test pattern on the illumination modulator;
modulator adjustment unit for permitting an actuation voltage on said illumination modulator to be changed through a range of actuation voltage values;
a detector for receiving a modulated illumination field from said illumination modulator;
sampling unit for determining at least one sample value for at least one area of said modulated illumination field; and
evaluation unit for determining a minimum sample value within said range of actuation voltage values of said illumination modulator.

2. An illumination modulator correction system as claimed in claim 1, wherein said system further includes adjustment unit for adjusting the actuation voltage of said illumination modulator responsive to said evaluation unit.

3. An illumination modulator correction system as claimed in claim 1, wherein said sampling unit determines three sample values for three areas of said modulated illumination field.

4. An illumination modulator correction system as claimed in claim 3, wherein said minimum sample value is determined at a rollover point for one of said sample values.

5. An illumination modulator correction system as claimed in claim 3, wherein said minimum sample value is determined responsive to a second roller point for said sample values.

6. An illumination modulator correction system for adjusting the operational parameters of an illumination modulator in an imaging system, said correction system comprising:
modulator pattern means for providing a test pattern on the illumination modulator;
modulator adjustment means for permitting an actuation voltage on said illumination modulator to be changed through a range of actuation voltage values;
a detector for receiving a modulated illumination field in at least a first region from said illumination modulator in a first direction;
sampling means for determining an average sample value for said at least one region of said modulated illumination field; and
evaluation means for determining an optimal sample value within said range of actuation voltage values of said illumination modulator.

7. An illumination modulator correction system as claimed in claim 6, wherein said system further includes adjustment means for adjusting the actuation voltage of said illumination modulator responsive to said evaluation means.

8. An illumination modulator correction system as claimed in claim 6, wherein said sampling means determines three sample values for three regions of said modulated illumination field.

9. An illumination modulator correction system as claimed in claim 8, wherein said optimal sample value is determined at a rollover point for one of said sample values.

10. An illumination modulator correction system as claimed in claim 8, wherein said optimal sample value is determined responsive to a second rollover point for said sample values.

11. An illumination modulator correction system as claimed in claim 8, wherein said optimal sample value is determined responsive to a rollover point having a minimal energy value for said sample values.

12. An illumination modulator correction system for adjusting the operational parameters of an illumination modulator in an imaging system, said correction system comprising:
modulator pattern unit for providing a test pattern on the illumination modulator over a first area in a first direction;
modulator adjustment unit for permitting an actuation voltage on said illumination modulator to be changed through a range of actuation voltage values;
a detector for receiving a modulated illumination field in at least a first region, a second region and a third region from said illumination modulator in said first direction;
sampling unit for determining an average sample value for each of said regions of said modulated illumination field; and
evaluation unit for determining an optimal sample value within said range of actuation voltage values of said illumination modulator.

13. An illumination modulator correction system as claimed in claim 12, wherein said system further includes adjustment unit for adjusting the actuation voltage of said illumination modulator responsive to said evaluation unit.

14. An illumination modulator correction system as claimed in claim 12, wherein said optimal sample value is determined at a rollover point for a sample value in the central region of said first area.

15. An illumination modulator correction system as claimed in claim 8, wherein said optimal sample value is determined at a rollover point for one of said sample values.

16. An illumination modulator correction system as claimed in claim 8, wherein said optimal sample value is determined responsive to a second rollover point for said sample values.

17. An illumination modulator correction system as claimed in claim 8, wherein said optimal sample value is determined responsive to a rollover point having a minimal energy value for said sample values.
